(19) United States
(12) Patent Application Publication
(10) Pub. No.: US 2016/0168286 A1
(43) Pub. Date: Jun. 16, 2016

(54) Reaction Resin Composition and Use Thereof

(71) Applicant: HILTI AKTIENGESELLSCHAFT, Schaan (LI)

(72) Inventor: Armin PFEIL, Kaufering (DE)

(21) Appl. No.: 14/904,297

(22) PCT Filed: Jul. 9, 2014
(86) PCT No.: PCT/EP2014/064676

§ 371 Date: Jan. 11, 2016

(30) Foreign Application Priority Data
Jul. 9, 2013 (EP) 13175672.8

(51) Int. Cl. C08F 122/10; C08K 3/00

(52) U.S. Cl. CPC C08F 122/105; C08K 3/0033

(57) ABSTRACT

A reaction resin composition having a resin component which contains a radically polymerizable compound and having an initiator system which comprises a copper(II) salt and at least one nitrogen-containing ligand, . . . and the copper(II) salt and the reducing agent being separated from each other in a reaction-inhibiting manner, and the use thereof for construction purposes are described.

The present relation relates to a radically curable reaction resin composition having a resin component and an initiator system that comprises an initiator and a catalyst system, which is able to form in situ a transition metal complex as catalyst.

The use of reaction resin compositions based on unsaturated polyester resins, vinyl ester resins or epoxy resins as bonding and adhesive agents has long been known. These are two-component systems, with one component containing the resin mixture and the other component containing the curing means. Other common components such as fillers, accelerators, stabilizers, [and] solvents including reactive solvents (reactive diluents) can be contained in one and/or the other component. By mixing the two components, the reaction is then set in motion, forming a cured product.

The mortar masses which are to be used in chemical fastening technology are complex systems subject to particular requirements, such as, for example, the viscosity of the mortar mass, curing and full curing in a relatively broad temperature range, usually −10° C. to +40° C., the inherent stability of the cured mass, adhesion to different substrates and ambient conditions, load values, creep resistance, and the like.

Two systems are generally used in chemical fastening technology. One is based on radically polymerizable, ethylenically unsaturated compounds, which as a rule are cured using peroxides, and one is epoxide-amine based.

Organic, curable two-component reaction resin compositions based on curable epoxy resins and amine curing agents are used as adhesives, spackling masses to fill cracks and, among other things, to fasten construction elements such as anchor rods, concrete iron (reinforcing bars), screws, and the like in boreholes. Mortar masses of this kind are known from EP 1 475 412 A2, DE 198 32 669 A1, and DE 10 2004 008 464 A1.

One disadvantage of the known epoxide-based mortar masses is the use of often considerable quantities of corrosive amines as curing agents, such as xylene diamine (XDA), particularly m-xylene diamine (mXDA; 1,3-benzenedimethanamine), and/or aromatic alcohol compounds, such as free phenols, e.g. bisphenol A, which can involve a health risk for users. Very large quantities, i.e., up to 50%, of those compounds are sometimes contained in the individual components of multi-component mortar masses, so a labeling requirement often applies to the packaging, which leads to less acceptance by users of the product. Limit values have been introduced in some countries in recent years for the content of mXDA or bisphenol A that is allowed in products, and they must then be labelled.

Radically curable systems, particularly systems curable at room temperature, need so-called radical starters, also known as initiators, so that the radical polymerization can be induced. Due to their properties, the curing agent composition described in application DE 3226602 A1, which includes benzoyl peroxide as radical starter and an amine compound as an accelerator, and the curing agent composition described in application EP 1586569 A1, comprising a perester as curing agent and a metal compound as accelerator, have caught on in the field of chemical fastening technology. These curing agent compositions allow fast and very complete curing, even at very low temperatures down to −30° C. These systems are also robust with regard to the mixing ratios of resin and curing agent. This makes them appropriate for use under conditions on a construction site.

The disadvantage of these curing agent compositions, however, is that peroxides must be used as radical starter in both cases. They are heat-sensitive and react very responsively to impurities. This leads to considerable limitations in the formulation of pasty curing agent components, particularly for injection mortars, with regard to storage temperatures, storage stabilities, and the choice of appropriate components. To allow the use of peroxides such as dibenzoyl peroxide, peresters, and the like, phlegmatization agents such as phthalates or water are added to stabilize them. They act as softeners, thereby significantly impairing the mechanical strength of the resin mixtures.

These known curing agent compositions are also detrimental to the extent that they must contain considerable amounts of peroxide, which is problematic because products that contain peroxide above a concentration of 1%, such as dibenzoyl peroxide, must be labeled as sensitizing in some countries. The same applies to the amine accelerators, some of which are also subject to labeling requirements.

Very few attempts have hitherto been made to develop peroxide-free systems based on radically polymerizable compounds. A peroxide-free curing agent composition for radically polymerizable compounds which contains a 1,3-dicarbonyl compound as curing agent and a manganese compound as accelerator and use thereof for reaction resin compositions based on radically curable compounds is known from DE 10 2011 078 785 A1. However, that system tends not to cure sufficiently under certain conditions, which leads to reduced performance by the cured mass, particularly for use as a plugging mass, so it is generally possible to use it as a plugging mass, but not for applications requiring reliable, very high load values.

It is also disadvantageous in the two described systems that a defined ratio of resin components and curing agent components (also briefly referred to below as mixing ratio) must be maintained for each of them so that the binder can completely cure and the required properties of the cured masses can be achieved. Many of the known systems are not very robust where the mixing ratio is concerned, and in some cases react very responsively to fluctuations in the mixture, which affects the properties of the cured masses.

Another possibility for initiating radical polymerization without the use of peroxides is provided by the ATRP (atom transfer radical polymerization) method, which is often used in macromolecular synthesis chemistry. It is assumed that this involves a “living” radical polymerization, although no limitation is intended as a result of the description of the mechanism. In these methods, a transition metal compound is transformed using a compound that has a transferrable atom group. When this is done, the transferrable atom group is transferred to the transition metal compound, as a result of which the metal is oxidized. In this reaction, a radical is formed which is added to ethylenic unsaturated groups. The transfer of the atom group to the transition metal compound is reversible, however, so the atom group is transferred back to the growing polymer chain, as a result of which a controlled polymerization system is formed. This reaction control is described by J. S. Wang, et al., J. Am. Chem. Soc., vol. 117, pp. 5614-5615 (1995), [and] by Matyjaszewski, Macromolecules, vol. 28, pp. 7901-7910 (1995). The publications WO 96/30421 A1, WO 97/47661 A1, WO 97/18247 A1, WO 98/40415 A1, and WO 99/10387 A1 also disclose variants of the ATRP discussed above.

ATRP was of scientific interest for a long time and is substantially used for targeted control of the properties of polymers and for adjusting them to the desired applications. These include control of the particle size, structure, length, weight, and weight distribution of polymers. The structure of the polymer, the molecular weight, and the molecular weight distribution can be controlled accordingly. This is also increasing the economic interest in ATRP. For example, U.S. Pat. Nos. 5,807,937 and 5,763,548 describe (co)polymers produced using ATRP, which are useful for a multiplicity of applications, such as dispersants and surface-active substances.

However, the ATRP method has not previously been used to carry out polymerization in situ, such as on a construction site under the conditions that prevail there, as is necessary for construction application[s], e.g., mortar, adhesive, and plugging masses. The requirements that those applications impose on polymerizable compositions, namely initiation of polymerization in the temperature range between −10° C. and +60° C., inorganically filled compositions, adjustment of a gel time with subsequent fast polymerization of the resin component which is as complete as possible, packaging as single- or multi-component systems, and the other known requirements for the cured mass, have not previously been taken into account in the comprehensive literature on ATRP.

It is detrimental in an initiator system analogous to ATRP that this system is relatively complex, since formation of the actual reactive species requires multiple compounds, which react with one another and in some cases can be adversely influenced by others in the composition in which the initiator system is to be used. This makes the formulation of a system, in particular of a storage-stable system, very difficult.

The object of the invention is thus to provide a reaction resin composition for mortar systems as described above, which does not have the specified disadvantages of known systems, which can be packaged as a two-component system, which is in particular storage-stable over several months and is cold-curing.

The inventor has surprisingly discovered that the object can be achieved in that simplified ATRP-like initiator systems are used as radical initiator and [sic] for the reaction resin compositions based on radically polymerizable compounds which are described above.

The following explanations of the terminology used herein are considered useful for better understanding of the invention. In the sense of the invention:
“Cold-curing” means that the polymerization, also referred to synonymously herein as “curing,” of the two curable compounds can be started at room temperature without additional energy input, for example the addition of heat, as a result of the curing means contained in the reaction resin compositions, optionally in the presence of accelerators, and also exhibit[s] sufficient full curing for the planned applications;
“Separated in a reaction-inhibiting manner” means that a separation between compounds or components is achieved in such a way that a reaction between them cannot take place until the compounds or components are brought into contact with each other, for example by mixing; a reaction-inhibiting separation as a result of (micro)encapsulation of one or more compounds or components is also conceivable;
“α-H atom” means in connection with the nitrogen-containing ligand in α-position to the nitrogen atom, i.e., a hydrogen atom that is bonded to the carbon atom, which in turn is directly bonded to the nitrogen atom;
“Curing means” means substances that cause the polymerization (curing) of the base resin;
“Aliphatic compound” means an acyclic or cyclic, saturated or unsaturated hydrocarbon compound that is not aromatic (PAC, 1995, 67, 1307; Glossary of class names of organic compounds and reactivity intermediates based on structure (IUPAC Recommendations 1995));
“Polymerization inhibitor,” also referred to synonymously herein as “inhibitor,” means a compound able to inhibit the polymerization reaction (curing), which is used to prevent the polymerization reaction and therefore an undesired premature polymerization of the radically polymerizable compound during storage (often referred to as stabilizer), and which is used to delay the start of the polymerization reaction immediately after the addition of the curing agent; to achieve the aim of storage stability, the inhibitor is commonly used in such small quantities that the gel time is not influenced; to influence the time point of the start of the polymerization reaction, the inhibitor is commonly used in quantities such that the gel time is influenced;
“Reactive diluent” means liquid or low-viscosity monomers and base resins which dilute other base resins or the resin component, thereby imparting the viscosity necessary for their application, contain functional groups capable of reacting with the base resin, and, during polymerization (curing), predominantly become a component of the cured mass (mortar);
“Gel time” For unsaturated polyester or vinyl resins, which are commonly cured using peroxides, the time for the curing phase of the resin corresponds to the gel time, during which the temperature of the resin rises from +25° C. to +35° C.; this corresponds approximately to the time period during which the fluidity or viscosity of the resin is still in a range such that the reaction resin or the reaction resin mass can still be easily handled or processed;
“Two-component system” means a system that contains two components stored separately from each other, generally a resin component and a curing agent component, in such a way that curing of the resin component does not occur until after mixing of the two components;
“Multi-component system” means a system that contains three or more components stored separately from each other, so that curing of the resin component does not occur until after mixing of all components;
“(Meth)acryl . . . / . . . (meth)acryl . . . ” means that both the “methacryl . . . / . . . methacryl . . . ” and the “acryl . . . / . . . acryl . . . ” compounds are to be included.

The inventor has discovered that radically polymerizable compounds having a combination of specific compounds, as they are used in some cases for the initiation of the ATRP, can be polymerized.

It was surprisingly found that methacrylates spontaneously radically polymerize in the presence of copper(II) salts and amine ligands having α-H atoms and that this polymerization can be inhibited by radical scavengers.

The inventor has succeeded in inducing a radical polymerization at room temperature without the presence of an initiator which is necessary for ATRP and without the use of copper(I) salts, or reducing agents to generate copper(I) salts in situ from copper(II) salts.

A first object of the invention is a reaction resin composition having a resin component that contains a radically polymerizable compound and having an initiator system which contains a copper(II) salt and a nitrogen-containing ligand, with the copper(II) salt and the nitrogen-containing ligand being separated from each other in a reaction-inhibiting manner, characterized in that the oxidizing copper(II) cation has a redox potential that is greater than that of the nitrogen-containing ligand, in order to generate a radical from the nitrogen-containing ligand.

It is thus possible to provide a reaction resin composition that is cold-curing and that in particular is packaged as a two- or multi-component system [and] is storage-stable.

Reaction resin compositions can thus also be provided which are free of peroxide and critical amine compounds and are thus no longer subject to a labeling requirement. Furthermore, the compositions no longer contain phlegmatizing agents functioning as softeners in the cured mass.

Another advantage of the invention is that the composition, when it is packaged as a two-component system, allows any chosen ratio of the two components in relation to each other, with the initiator system being homogeneously dissolved in the components, so that only a low concentration of it is necessary. The composition also has the advantage that the initiator system has fewer components than the components of the initiator system which are usually needed for ATRP and is therefore simpler and in particular less prone to problems.

In accordance with the invention, the initiator system comprises a copper(II) salt and a nitrogen-containing ligand (also referred to herein as amine ligand). They are chosen such that, under the present reaction conditions, i.e., a basic environment as a result of the nitrogen-containing ligands and the mineral aggregates optionally contained in the composition, which often also lead to an alkaline environment, and reaction at ambient temperature, a redox reaction between the copper(II) salt and the nitrogen of the nitrogen-containing ligand takes place, as a result of which radical cations, more precisely N-radical cations, are formed.

It is assumed that, under the prevailing reaction conditions, a nitrogen radical cation is formed when the redox potential of the copper(II) cation is greater than that of the nitrogen atom in the nitrogen-containing ligand. In the prevailing alkaline environment, a proton on the carbon atom in the position relative to the nitrogen radical cation is presumably split off, and the resulting species is converted to the initiating radical, more precisely N-alkyl radical.

The copper(II) cation of the copper(II) salt must advantageously be able to participate in a single-electron redox process, and it should be able to reversibly increase its coordination number by one. It must also be able to oxidize the nitrogen atom of the amine ligand to a nitrogen radical cation. Its redox potential must thus be greater than that of the nitrogen atom of the amine ligand. This also depends, for one thing, on whether a solvent is used for the copper(II) salt and, for another, on the nature of the solvent, i.e., what influence the solvent has on the redox potentials of the copper(II) cation and the nitrogen atom, to the extent one is used. Furthermore, the solubility of the copper(II) salt in the reaction resin and/or the reactive solvents, to the extent they are included, has an influence on the redox potential of the copper(II) cation.

It is suspected that, in the presence of the nitrogen-containing ligand, which is a basic amine, a proton in a-position is split off from the N-alkyl remainder, so that radical resultant products, such as N-alkyl radicals, are formed as a result. These radical resultant products can then induce polymerization, thereby acting as the actual initiator.

The ligand advantageously contributes to the solubility of the copper salt in the radically polymerizable compound to be used, to the extent the copper salt itself is not yet sufficiently soluble and is able to adjust the redox potential of the copper with regard to reactivity and halogen transfer.

Appropriate copper(II) salts are those that are soluble in the radically polymerizable compound that is used or in a solvent optionally added to the resin mixture, such as a reactive diluent. Copper(II) salts of this kind are, for example, Cu(II)(PF₆)₂, CuX₂, where X=Cl, Br, I, with CuX₂ being preferred and CuCl₂ or CuBr₂ being more preferred, Cu(OTf)₂ (-OTf=trifluoromethanesulfonate, CF₃SO₃⁻) or Cu(II) carboxylate. Copper(II) salts that, as a function of the radically polymerizable compound that is used, can be dissolved in it without the addition of ligands, are particularly preferred.

Appropriate nitrogen-containing ligands are amines that can be oxidized at room temperature as a result of copper(II) and possess easily extractable hydrogen atoms on the α-carbon atom relative to the nitrogen, and have tertiary amino groups, such as tertiary aliphatic amines, having hydrogen atoms on the α-carbon atom relative to the nitrogen atom.

A nitrogen-containing ligand containing two or more nitrogen atoms is preferred.

When using an additional solvent and with an appropriate choice of the copper(II) salt, heterocyclic amines, such as, for example, 2,2′-bipyridine or 1,10-phanthroline, can correspondingly be oxidized.

Examples of appropriate nitrogen-containing ligands having hydrogen atoms on the α-carbon atom relative to the nitrogen atom are, for example, ethylene diaminotetraacetate (EDTA), N,N-dimethyl-N′,N′-bis(2-dimethylaminoethyl)ethylenediamine (Me6TREN), or N,N,N′,N″,N″-pentamethyl-diethylenetriamine (PMDETA), as well as its higher and lower homologues.

Contrary to the recommendations from the scientific literature, which as a rule describes a ratio of Cu:ligand=1:2 as optimum for the quantity of nitrogen-containing ligands to be used, the inventor has surprisingly discovered that the reaction resin composition shows a much stronger reactivity, i.e., cures faster and fully cures better when the nitrogen-containing ligand is added in excess. In that regard, “in excess” means that the amine ligand is indeed added in the ratio Cu:ligand=1:5, or even up to 1:10. What is decisive is that this excess does not in turn have a harmful effect on the reaction and the final properties.

Also contrary to the recommendations from the scientific literature, the inventor has surprisingly discovered that the reaction resin composition, independent of the quantity used, shows a much stronger reactivity when the ligand is a nitrogen-containing compound having primary amino groups.

The nitrogen-containing ligand can be added either alone or as a mixture of two or more of them.

The curing reaction can be accelerated by adding a strong, non-nucleophilic base. Appropriate bases are known to those skilled in the art from the field of organic synthesis. Examples that can be mentioned are N,N-diisopropylethylamine (DiPEA), 1,8-diazabicycloundec-7-ene (DBU), 2,6-di-tert-butylpyridine, phosphazene bases, lithium diisopropylamide (LDA), silicon-based amides, such as sodium and potassium hexamethyldisilazane (NaHMDS and KHMDS), lithium-2,2,6,6-tetramethylpiperidine (LiTMP), [and] sodium and potassium tert-butoxide.

In accordance with the invention, ethylenic unsaturated compounds, compounds having carbon-carbon triple bonds, and thiol-yne/ene resins as known to a person skilled in the art are appropriate as radically polymerizable compounds.

Of those compounds, the group of ethylenic unsaturated compounds is preferred which includes styrene and derivatives thereof, (meth)acrylates, vinyl ester, unsaturated polyester, vinyl ether, allyl ether, itaconates, dicyclopentadiene compounds and unsaturated fats, of which in particular unsaturated polyester resins and vinyl ester resins are appropriate and are described as examples in the publications EP 1 935 860 A1, DE 195 31 649 A1, WO 02/051903 A1, and WO 10/108939 A1. Vinyl ester resins are most preferred due to their hydrolytic stability and excellent mechanical properties.

Examples of appropriate unsaturated polyesters that can be used in the resin mixture in accordance with the invention are divided into the following categories, as classified by M. Malik, et al. in J. M. S.—Rev. Macromol. Chem. Phys., C40(2 and 3), pp. 139-165 (2000):

(1) Ortho resins: These are based on phthalic acid anhydride, maleic acid anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A.

(2) Iso resins: These are produced from isopthalic acid, maleic acid anhydride, or fumaric acid and glycols. These resins can contain higher percentages of reactive diluents than ortho resins do.

(3) Bisphenol A fumarates: These are based on ethoxylated bisphenol A and fumaric acid.

(4) HET acid resins (hexachloroendomethylenetetrahydrophthalic acid resins): These are resins obtained from anhydrides containing chlorine/bromine or phenols when producing unsaturated polyester resins.

In addition to those resin classes, the so-called dicyclopentadiene resins (DCPD resins) can be distinguished as unsaturated polyester resins. The class of DCPD resins is obtained either through modification of one of the aforementioned resin types by means of the Diels-Alder reaction with cyclopentadiene, or they are alternatively obtained through an initial reaction of a dicarbonic acid, e.g., maleic acid, with dicyclopentadienyl, and subsequently through a second reaction, the customary production of an unsaturated polyester resin, with the latter being referred to as a DCPD-maleate resin.

The unsaturated polyester resin preferably has a molecular weight Mn in the range of 500 to 10,000 Dalton, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as an unsaturated polyester resin, the acid value is preferably 0 to 50 mg KOH/g resin.

In the sense of the invention, vinyl ester resins are oligomers, prepolymers, or polymers having at least one (meth)acrylate end group, so-called (meth)acrylate-functionalized resins, which also include urethane (meth)acrylate resins and epoxy (meth)acrylates.

Vinyl ester resins that have unsaturated groups only in the end position are, for example, obtained through the transformation of epoxide oligomers or polymers (e.g., bisphenol A digylcidyl ether, phenol novolak-type epoxides, or epoxide oligomers based on tetrabrombisphenol A) containing (meth)acrylic acid or (meth)acrylamide for example. Preferred vinyl ester resins are (meth)acrylate-functionalized resins and resins obtained through the transformation of an epoxide oligomer or polymer with methacrylic acid or methacrylamide, preferably with methacrylic acid. Examples of compounds of this kind are known from the publications U.S. Pat. No. 3,297,745 A, U.S. Pat. No. 3,772,404 A, U.S. Pat. No. 4,618,658 A, GB 2 217 722 A1, DE 37 44 390 A1, and DE 41 31 457 A1.

Particularly appropriate and preferred as vinyl ester resin are (meth)acrylate-functionalized resins that are obtained, for example, through transformation of di- and/or higher-functional isocyanates with appropriate acryl compounds, optionally with the help of hydroxy compounds containing at least two hydroxyl groups, as described, for example, in DE 3940309 A1.

Aliphatic (cyclic or linear) and/or aromatic di- or higher-functional isocyanates or prepolymers thereof can be used as isocyanates. The use of such compounds serves to increase wetting ability and thus to improve adhesion properties. Aromatic di- or higher-functional isocyanates or prepolymers thereof are preferred, with aromatic di- or higher-functional prepolymers being particularly preferred. Toluylene diisocyanate (TDI), methylene diphenyl diisocyanate (MDI), and polymeric methylene diphenyl diisocyanate (pMDI) to increase chain stiffening and hexamethylene diisocyanate (HDI) and isophoronediisocyanate (IPDI), which improves flexibility, can be mentioned as examples, with polymeric methylene diphenyl diisocyanate (pMDI) being very particularly preferred.

Acrylic acid and acrylic acids substituted on hydrocarbyl, such as methacrylic acid, hydroxyl-group-containing esters of acrylic or methacrylic acid with multivalent alcohols, pentaerythrittritol(meth)acrylate, glycerol di(meth)acrylate, such as trimethylolpropane(meth)acrylate, [and] neopentylglycol mono(meth)acrylate are appropriate as acryl compounds. Acrylic and methacrylic acid hydroxylalkyl esters, such as hydroxyethyl(meth)acrylate, hydroxypropyl(meth)acrylate, polyoxyethylene(meth)acrylate, [and] polyoxypropylene(meth)acrylate, are preferred, particularly since compounds of this kind promote the steric prevention of the saponification reaction.

Bivalent or higher-valent alcohols, such as reaction products of ethylene or propylene oxide, such as ethanediol, di- or triethylene glycol, propanediol, dipropylene glycol, other diols, such as 1,4-butanediol, 1,6-hexanediol, neopentyl glycol, diethanolamine, also bisphenol A or F or ethox/propoxylation or hydration or halogenation products thereof, higher-valent alcohols, such as glycerin, trimethylolpropane, hexanetriol, and pentaerythritol, hydroxyl-group-containing polyethers, for example oligomers of aliphatic or aromatic oxiranes and/or higher cyclic ethers, such as ethylene oxide, propylene oxide, styrene oxide and furane, polyethers that contain aromatic structural units in the main chain, such as those of bisphenol A or F, hydroxyl-group-containing polyesters based on the aforementioned alcohols or polyethers and dicarbonic acids or their anhydrides, such as adipinic acid, phthalic acid, tetra- or hexahydrophthalic acid, HET acid, maleic acid, fumaric acid, itaconic acid, sebacinic acid and the like are appropriate as hydroxyl compounds that can optionally be added. Hydroxy compounds having structural units for chain stiffening of the resin, hydroxy compounds that contain unsaturated structural units, such as fumaric acid, to increase cross-linking density, branched or star-shaped hydroxy compounds, particularly tri-or higher-valent alcohols and/or polyethers or polyesters, which contain their structural units, branched or star-shaped urethane(meth)acrylate to achieve lower viscosity of the resins or their solutions in reactive diluents and higher reactivity and cross-linking density are particularly preferred.

The vinyl ester resin preferably has a molecular weight Mn in the range of 500 to 3,000 Dalton, more preferably 500 to 1,500 Dalton (according to ISO 13885-1). The vinyl ester resin has an acid value in the range of 0 to 50 mg KOH/g resin, preferably in the range of 0 to 30 mg KOH/g resin (according to ISO 2114-2000).

All of these resins that can be used in accordance with the invention can be modified according to the method known to those skilled in the art, in order, for example, to obtain lower acid numbers, hydroxide numbers, or anhydride numbers, or can be made more flexible by inserting flexible units in the base structure, and the like.

The resin can also contain other reactive groups, which can be polymerized using the initiator system in accordance with the invention, for example reactive groups that are derived from itaconic acid, citraconic acid, and allylic groups and the like.

In a preferred embodiment of the invention, the reaction resin composition contains additional low-viscous, radically polymerizable compounds as reactive diluents for the radically polymerizable compound, in order to adjust its viscosity, if necessary.

Appropriate reactive diluents are described in the publications EP 1 935 860 A1 and DE 195 31 649 A1. The resin mixture preferably contains a (meth)acrylic acid ester as reactive diluent, with (meth)acrylic acid esters preferably being chosen from the group consisting of hydroxypropyl(meth)acrylate, propanediol-1,3-di(meth)acrylate, butanediol-1,2-di(meth)acrylate, trimethylolpropane tri(meth)acrylate, 2-ethylhexyl(meth)acrylate, phenylethyl(meth)acrylate, tetrahydrofurfuryl(meth)acrylate, ethyltriglycol(meth)acrylate, N,N-dimethylaminoethyl(meth)acrylate, N,N-dimethylaminomethyl(meth)acrylate, butanediol-1,4-di(meth)acrylate, acetoacetoxyethyl(meth)acrylate, ethanediol-1,2-di(meth)acrylate, isobornyl(meth)acrylate, diethylene glycol di(meth)acrylate, methoxypolyethylene glycol mono(meth)acrylate, trimethylcyclohexyl(meth)acrylate, 2-hydroxyethyl(meth)acrylate, dicyclopentenyl oxyethyl(meth)acrylate, and/or tricyclopentadienyl di(meth)acrylate, bisphenol A-(meth)acrylate, novolak epoxy di(meth)acrylate, di[(meth)acryloyl-maleoyl]-tricyclo-5.2.1.0.^{2.6}-decane, dicyclopentenyl oxyethyl crotonate, 3-(meth)acryloyl-oxymethyl-tricylo-5.2.1.0.^{2.6}-decane, 3-(meth)cyclopentadienyl(meth)acrylate, isobornyl(meth)acrylate and decalyl-2-(meth)acrylate.

As a matter of principle, other common radically polymerizable compounds, alone or in a mixture with the (meth)acrylic acid esters, can be used, e.g., styrene, α-methylstyrene, [and] alkylate styrenes, such as tert-butylstyrene, divinylbenzene, and allyl compounds.

In a further embodiment of the invention, the reaction resin composition also contains an inhibitor.

The stable radicals commonly used as inhibitors for radically polymerizable compounds, such as N-oxyl radicals, as known to those skilled in the art, are suitable as inhibitor for the storage stability of the radically polymerizable compound and thus also of the resin component, as well as for adjustment of the gel time. Phenolic inhibitors, as otherwise commonly used in radically curable resin compositions, cannot be used here, because the inhibitors, as reducing agents, would react with the copper(II) salt, which would have an adverse effect on storage stability and gel time.

N-oxyl radicals such as those described in DE 199 56 509 A1 can be used, for example. Appropriate stable n-oxyl-radicals (nitroxyl radicals) can be chosen from among 1-oxyl-2,2,6,6-tetramethylpiperidine, 1-oxyl-2,2,6,6-tetramethylpiperidine-4-ol (also called TEMPOL), 1-oxyl-2,2,6,6-tetramethylpiperidine-4-on (also called TEMPON), 1-oxyl-2,2,6,6-tetramethyl-4-carboxyl-piperidine (also called 4-carboxy-TEMPO), 1-oxyl-2,2,5,5-tetramethyl pyrrolidine, 1-oxyl-2,2,5,5-tetramethyl-3-carboxyl pyrrolidine (also called 3-carboxy-PROXYL), aluminum-N-nitroso phenylhydroxylamine, [and] diethylhydroxylamine. Other appropriate N-oxyl compounds are oximes, such as acetaldoxime, acetone oxime, methyl ethyl ketoxime, salicyloxime, benzoxime, glyoxime, dimethylglyoxime, acetone-O-(benzyloxycarbonyl)oxime, or indoline-nitroxide radicals, such as 2,3-dihydro-2,2-diphenyl-3-(phenylimino)-1H-indole-1-oxyl nitroxide, or β-phosphorylated nitroxide radicals, such as 1-(diethoxyphosphinyl)-2,2-dimethylpropyl-1,1-dimethylmethyl-nitroxide, and the like.

The reaction resin composition can also contain inorganic aggregates, such as fillers and/or other additives.

The customary fillers, preferably mineral or mineral-like fillers, such as quartz, glass, sand, quartz sand, quartz powder, porcelain, corundum, ceramic, talcum, silicic acid (e.g., pyrogenic silicic acid), silicates, clay, titanium dioxide, chalk, barite, feldspar, basalt, aluminum hydroxide, granite or sandstone, polymeric fillers, such as duroplasts, hydraulically curable fillers, such as gypsum, quicklime, or cement (e.g. alumina cement or Portland cement), metals, such as aluminum, carbon black, also wood, mineral or organic fibers, or the like, or mixtures of two or more of them, which can be added as powder, in grain form or in the form of molded bodies, are used as fillers. The fillers may be present in any chosen form, for example as powder or meal, or as molded bodies, e.g., in cylinder, ring, sphere, plate, rod, saddle, or crystal shape, or also in fiber shape (fibrillary fillers), and the corresponding base particles preferably have a maximum diameter of 10 mm. However, the globular, inert substances (sphere shape) are preferred and are much more reinforcing.

Conceivable additives are thixotropic agents, such as, where applicable, post-treated pyrogenic silicic acid, bentonites, alkyl- and methylcelluloses, ricin oil derivatives or the like, softeners, such as phthalic acid or sebacinic acid esters, stabilizers, anti-static agents, thickeners, flexibilizers, curing catalysts, rheology modifiers, wetting agents, color-imparting additives, such as coloring agents or in particular pigments, for example for differently dyeing the components to allow better control of mixing them, or the like, or mixtures of two or more of them are possible. Non-reactive diluents (solvents) can also be present, such as lower alkyl ketones, e.g., acetone, di-lower alkyl-lower-alkanoylamides, such as dimethylacetamide, lower alkylbenzenes, such as xylenes or toluene, phthalic acid esters or paraffins, water or glycols. Metal scavengers in the form of surface-modified pyrogenic silicic acids can also be contained in the reaction resin composition.

In that respect, reference is made to the publications WO 02/079341 A1 and WO 02/079293 A1, as well as WO 2011/128061 A1, whose content is hereby incorporated into this application.

Accordingly, a further object of the invention is a two- or multi-component system which contains the described reaction resin composition.

In one embodiment of the invention, the components of the reaction resin composition are spatially disposed in such a way that the copper(II) salt and at least one nitrogen-containing ligand are separated from each other, i.e., each in a component disposed separately from each other. This prevents the formation of the reactive species, namely the alkyl radical, and thus the polymerization of the radically polymerizable compound from starting during storage.

One preferred embodiment relates to a two-component system containing a reaction resin composition which includes a radically polymerizable compound, a copper(II) salt, a nitrogen-containing ligand, an inhibitor, optionally at least one reactive diluent, and optionally inorganic aggregates. In that regard, the copper(II) salt is contained in a first component, the A component, and the nitrogen-containing ligand is contained in a second component, the B component, with the two components being stored separately from each other in order to prevent a reaction of the components among themselves before mixing. The radically polymerizable compound, the inhibitor, the reactive diluent, and the inorganic aggregates are divided between the A and B component[s].

The reaction resin composition can be contained in a cartridge, a drum, a capsule, or a foil bag that comprises two or more chambers, which are separated from each other and in which the copper(II) salt and the nitrogen-containing ligand are contained separately from each other in a reaction-inhibiting manner.

The reaction resin composition in accordance with the invention is primarily used in the construction sector, for example to repair concrete, as polymer concrete, as coating mass based on synthetic resin, or as cold-curing road marking. They are [sic] particularly suitable for chemically fixing anchoring elements, such as anchors, reinforcing bars, screws, and the like, in boreholes, particularly in boreholes in different substrates, particularly mineral substrates, such as those based on concrete, pore concrete, brickwork, calcareous sandstone, sandstone, natural stone, and the like.

The use of the reaction resin mortar composition defined above for construction purposes includes the curing of the composition by mixing the copper(II) salt with the reducing agent or the copper(II) salt with the reducing agent and the ligand.

To fasten threaded anchor rods, reinforcing iron, threaded sleeves, and screws in boreholes in different substrates, the copper(II) salt is mixed with the ligand and optionally the base together with the reaction resin and optionally other components as mentioned above; the mixture is added to the borehole; the threaded anchor rod, the reinforcing iron, the threaded sleeve or the screw is introduced into the mixture in the borehole; and the mixture is cured.

The invention is explained in greater detail in reference to a series of examples and comparative examples. All examples support the scope of the claims. However, the invention is not limited to the specific embodiments shown in the examples.

### EXEMPLARY EMBODIMENTS

In the polymerization experiments below, the components as described were mixed by hand in a plastic cup using a plastic spatula and it was observed whether the mixture polymerized and, if so, when, how strong the heat development was, and what property (gel-like, rubber-like, glass-like=hard) the end product had.

### EXAMPLE 1

0.8 g Cu(II) octoate was mixed with 1.3 g pentamethyldiethylenetriamine (PMDETA) and 15.1 g 1,4-butanediol dimethacrylate (BDDMA) at room temperature. Spontaneous polymerization with heat development was observed, with a hard polymer being obtained.

This example shows that a system in accordance with the invention, modified from ATRP, spontaneously polymerizes under simple conditions, i.e., without additional components that positively influence the reaction and without a temperature increase, and is therefore appropriate as a reaction resin composition.

### EXAMPLE 2

A first component (A-component) was obtained by mixing 0.5 g Cu(II) octoate and 7.5 g BDDMA. A second component (B-component) was obtained by mixing 0.6 g PMDETA and 7.6 g BDDMA.

Both components were mixed, and gelling of the mixture was observed after about 2 hours.

As a result of adding TEMPOL to an analogous mass, no gelling was observed, which indicates that radical polymerization would occur but was suppressed in the presence of the radical scavenger TEMPOL.

### EXAMPLE 3

Analogous to example 2, one A-component and one B-component were produced, the difference being that Cu(II) naphthenate instead of the Cu(II) octoate was used for the A-component.

After about 4 minutes, an intense polymerization was observed, with a hard polymer being obtained.

This clearly shows that a copper(II) salt, in which the oxidizing copper(II) cation has greater redox potential under the same conditions, leads to a quicker reaction (polymerization).

### EXAMPLE 4

A first component (A-component) was obtained by mixing 0.6 g Cu(II) naphthenate and 15 g BDDMA. A second component (B-component) was obtained by mixing 1.2 g PMDETA and 15 g BDDMA.

Both components were mixed, and after 11 minutes gelling of the mixture was observed and the temperature of the mixture rose to 60° C.

Example 4 was repeated by analogously producing an A-component and a B-component, but now 0.12 g 1,8-diazabicycloundec-7-ene (DBU) was also added to the B-component. When this was done, gelling was observed after just 9 minutes.

This clearly shows that polymerization can be accelerated by adding a strong, non-nucleophilic base.

### EXAMPLE 5

Analogous to example 4, an A-component and a B-component were produced, with the difference that 1.1 g 2,2′-bipyridine (bipy) was used in place of the 1.2 g PMDETA.

No polymerization could be observed after mixing of the two components.

This shows that the amine must be oxidized by the copper(II) cation so that polymerization can take place. Bipy is much more oxidation-resistant than PMDETA, for example.

### EXAMPLE 6

A first component (A-component) was produced by mixing 0.75 g Cu(II) octoate and 15 g BDDMA, and a second component (B-component) was obtained by mixing 1.7 g hexamethyltriethylenetetramine (HMTETA) and 15 g BDDMA.

The mixture gelled after about 6 minutes.

The examples clearly show that it is possible to provide a reaction resin mixture in which polymerization can be induced at room temperature by an ATRP-analogous system in accordance with the invention. The polymerization can be slowed to a stop by adding a stable N-oxyl radical and accelerated by adding a strong, non-nucleophilic base, so that it is possible to control and adjust reactivity by the choice of additives.

1. A reaction resin composition having a resin component which contains a radically polymerizable compound and having an initiator system which contains a copper(II) salt having an oxidizing copper(II) cation and a nitrogen-containing ligand, wherein the copper(II) salt and the nitrogen-containing ligand are separated from each other in a reaction-inhibiting manner, wherein the oxidizing copper(II) cation has a redox potential that is greater than that of the nitrogen-containing ligand, in order to generate a radical from the nitrogen-containing ligand.

2. Reaction resin composition in accordance with claim 1, wherein the copper(II) salt is soluble in organic solvents and/or in the radically polymerizable compound.

3. Reaction resin composition in accordance with claim 2, wherein the copper(II) salt is selected from the group consisting of Cu(II)(PF₆)₂, CuX₂, where X=Cl, Br, I, Cu(OTf)₂, and Cu(II) carboxylates.

4. Reaction resin composition in accordance with claim 1, wherein the nitrogen-containing ligand is a tertiary aliphatic amine having hydrogen atoms on the α-carbon atom relative to the nitrogen atom.

5. Reaction resin composition in accordance with claim 1, wherein the nitrogen-containing ligand is present in excess.

6. Reaction resin composition in accordance with claim 1, wherein the initiator system comprises a strong, non-nucleophilic base.

7. Reaction resin composition in accordance with claim 1, wherein the radically polymerizable compound is an unsaturated polyester resin, a vinyl ester resin, and/or a vinyl ester-urethane resin.

8. Reaction resin composition in accordance with claim 1, wherein the composition also contains a non-phenolic inhibitor.

9. Reaction resin composition in accordance with claim 8, wherein the non-phenolic inhibitor is a stable N-oxyl radical.

10. Reaction resin composition in accordance with claim 1, wherein the resin component also includes at least one reactive diluent.

11. Reaction resin composition in accordance with claim 1, wherein the composition also contains inorganic aggregates.

12. Reaction resin composition in accordance with claim 11, wherein the inorganic aggregate is an additive and/or a filler.

13. Two-or multi-component system comprising a reaction resin composition in accordance with claim 1.

14. Two-component system in accordance with claim 13, wherein the copper(II) salt is contained in a first component and the nitrogen-containing ligand is contained in a second component, the radically polymerizable compound and, where applicable, the inhibitor are divided between the two components, and the two components are separated from each other in a reaction-inhibiting manner.

15. Two-component system in accordance with claim 14, wherein the reaction resin composition also comprises at least one reactive diluent and/or inorganic aggregates which are contained in one or both components.
